(19) United States
(12) Patent Application Publication
(10) Pub. No.: US 2017/0366645 A1
(43) Pub. Date: Dec. 21, 2017

(54) METHOD OF PROCESSING UPGOING AND DOWNGOING APPLICATION MESSAGES ORIGINATING FROM OR DESTINED FOR AN ELECTRONIC UNIT FOR CONTROL OF A HOME AUTOMATION INSTALLATION BY A SERVER

(71) Applicant: OVERKIZ, Metz-Tessi (FR)

(72) Inventor: Sylvain POGNANT, Seynod (FR)

(21) Appl. No.: 15/539,907

(22) PCT Filed: Dec. 23, 2015
(86) PCT No.: PCT/FR2015/053739

§ 371 Date: Jun. 26, 2017

(30) Foreign Application Priority Data
Dec. 24, 2014 (FR) 14/63301

(51) Int. Cl. H04L 29/08; H04L 12/28

(52) U.S. Cl. CPC H04L 67/327; H04L 67/143; H04L 12/2827; H04L 67/141; H04L 67/125

(57) ABSTRACT

The present invention relates to a method of processing upgoing application messages originating from an electronic unit for control (U) of a home automation installation by a server (S) comprising the following steps:—a step of establishment of a connection (Cnx) between the server (S) and the electronic control unit (U); a step of reception (EMC2) of an upgoing application message (Mm) by the server (S) originating from the electronic control unit (U);—a step of posting (EMC4) of an incoming message (Me), in the case where the upgoing application message contains useful data (Plm), the incoming message (Me) being posted on an incoming queue (Qe) with a view to a processing by an application module (MA), the incoming message (Me) comprising useful data (Plm) determined as a function of the useful data (Pld) of the upgoing application message (Mm) and an identifier of the electronic control unit (Uid);—a step of freeing (EMC9) of the connection (Cnx) in an immediate manner or following a maximum lag (Tmax).

### TECHNICAL FIELD

The present invention concerns a method for processing uplink application messages and downlink application messages between a server and an electronic control unit of a home automation installation.

### BACKGROUND

It is known to proceed to exchanges of data between a server and a set of electronic control units of a home automation installation. It may be desirable to proceed to these exchanges of data in particular to operate a remote control of the installations by the server, for example in the case where the server receives instructions from a user interface enabling the user to remotely control his installation.

Consequently, it is possible to use a mechanism for connection between the electronic unit and the server, in order to convey the data from the server to the electronic control unit and vice versa. Nonetheless, it appears that in the case of home automation applications where a very large number of electronic control units communicate with a server, this leads to a considerable use of network resources or memory resources on the server which must keep the data related to all the connections corresponding to each electronic unit.

### BRIEF SUMMARY

The present invention aims to solve all or part of the aforementioned drawbacks.

To this end, the present invention concerns a method for processing uplink application messages coming from an electronic control unit of a home automation installation by a server comprising the following steps:
a step of establishing a connection between the server and the electronic control unit;
a step of receiving an uplink application message by the server coming from the electronic control unit;
a step of posting an incoming message, in the case where the uplink application message contains useful data, the incoming message being posted on an incoming queue for processing by an application module, the incoming message comprising useful data determined according to the useful data of the uplink application message and an identifier of the electronic control unit;
a step of releasing the connection immediately or subsequently to a maximum delay.

Thanks to the arrangements according to the invention, the time of the first processing of each request varies little considering that the useful data are posted on a queue for an asynchronous second processing. Subsequently to the first processing, or within a predictable or bounded maximum delay, the connection corresponding to the request is released.

Thus, a large number of electronic control units can communicate with the processing instances of the server in charge of the connections, also called connectors, because the connections are released quickly, without waiting till the end of the processing carried out in an asynchronous manner, which allows limiting the number of concurrent connections and therefore the corresponding resources on the server.

In particular, this communication mode is adapted to home automation applications in which a large number of electronic control units are connected to a server with a low volume of data to exchange with the latter.

It should be noted that the term uplink concerns the messages transmitted by the electronic unit to the server and that the term downlink concerns the messages transmitted by the server to the electronic control unit.

The release of the connection may be carried out at the initiative of the server or of the electronic control unit, as the case may be.

By immediate release, is meant a release after a complete transmission step. In particular, the release also comprises the management of the acknowledgment message requested by most online protocols (<<acknowledge>>, ACK). Thus, as example, in the case of a reception of useful data, after sending of the ACK message; in the case of an emission, after the reception of the ACK message.

According to another possibility, a maximum delay Tmax may be provided before the release of the connection, this delay allowing for example waiting for a return from an application module to the incoming message, in the form of a downlink message for which a downlink application message could be transmitted by the server toward the electronic control unit.

In particular, the calculation of the delay Tmax may be performed starting from the connection establishment step, or still from the postage step, or still following a step of receiving an uplink application message.

If the application protocol provides for sending a downlink message in response to the incoming message, an empty response may be sent upon completion of the delay Tmax and prior to the release of the connection. An empty response contains no useful data, but may contain the reception acknowledgment type message (ACK) related to the request formed by the uplink message.

In the case of an uplink message corresponding to a request, the application response to the uplink message may be communicated during a subsequent connection.

According to an aspect of the invention, the uplink message further comprises an identifier of the processing instance or connector.

According to an aspect of the invention, the method comprises a resource reservation step by the server for the management of the connection.

According to an aspect of the invention, the uplink application message corresponds to a request coming from the electronic control unit.

According to an aspect of the invention, the incoming message comprises a processing priority attribute, the postage step being carried out at a different position of the queue depending on the value of the priority attribute.

According to an aspect of the invention, the method comprises a step of transmitting a downlink message to the electronic control unit in response to the uplink application message, the downlink message comprising useful data received beforehand or no useful data at all.

These arrangements allow taking advantage of the established connection to communicate useful data to the electronic control unit.

According to an aspect of the invention, the method comprises a step of determining an incoming queue on which the incoming message must be posted, prior to the postage step, the determination step taking into account the identifier of the electronic control unit.

These arrangements allow distributing the incoming messages over several incoming queues, while guaranteeing that the messages coming from the same electronic control unit are processed on the same queue, and that the sequence of the messages coming from said electronic control unit is therefore upheld.

According to an aspect of the invention, the determination step implements for example the use of a hash function.

According to an aspect of the invention, the method comprises a prior step of routing the uplink application messages and/or the connection according to the electronic control unit to a processing instance, the correspondence between a processing instance and an electronic control unit being memorized in a repository.

These arrangements allow distributing the uplink messages coming from the plurality of electronic control units over a plurality of processing instances or several connector instances.

According to an aspect of the invention, the routing is performed according to an identifier of the electronic control unit, such as for example an IP address.

According to an aspect of the invention, the method comprises a subsequent step of collecting at least one message on an incoming queue by a listener relating to an application module.

These arrangements allow carrying out an asynchronous processing of the uplink messages, even in the case where it comprises a request coming from an electronic control unit.

According to an aspect of the invention, the method comprises:
a first step of receiving a first uplink application message by the server coming from the electronic control unit, prior to the step of transmitting a downlink application message, the first uplink application message comprising useful data; and
a second step of receiving a second uplink application message, subsequently to the first step of receiving a first uplink application message by the server coming from the electronic control unit, prior to the step of transmitting a downlink application message, the second uplink application message comprising useful data or no useful data at all;

the downlink application message comprising useful data corresponding to a response to a reception of the first uplink application message coming from the electronic control unit.

According to an aspect of the invention, the first step of receiving the first uplink application message is carried out between a first step of establishing a connection between the server and the electronic control unit and a first step of releasing the connection;

the second step of receiving the first uplink application message and the step of transmitting the downlink application message are carried out between a second step of establishing a connection between the server and the electronic control unit, subsequent to the first step of releasing the connection and a second step of releasing the connection.

Another aspect of the present invention is a method for processing downlink messages toward an electronic control unit of a home automation installation by a server comprising the following steps:
a step of collecting an outcoming message on an outcoming queue coming from an application module, the outcoming message comprising an identifier of an electronic control unit and useful data;
a step of establishing a connection between the server and the electronic control unit corresponding to the identifier of the electronic control unit comprised in the outcoming message;
a step of transmitting a downlink application message to the electronic control unit, the downlink application message (Md) comprising useful data determined from the useful data of the outcoming message;
a step of releasing the connection immediately or subsequently to a maximum delay.

According to an aspect of the invention, the connection release step is carried out at the initiative of the server.

As previously detailed, by immediate release, is meant a release after a complete transmission step. In particular, the release also comprises the management of the acknowledgment message requested by most online protocols (<<acknowledge>>, ACK). Thus, as example, in the case of a reception of useful data, after sending of the ACK message; in the case of an emission, after the reception of the ACK message.

According to another possibility, a maximum delay Tmax may be provided before the release of the connection. In particular, the calculation of the delay Tmax may be performed starting from the connection establishment step, or still from a possible step of posting a message on an incoming queue, or still following a step of receiving a possible uplink application message.

According to an aspect of the invention, the method comprises a step of transmitting by the server toward an electronic control unit, according to a first communication protocol, a connection open request message toward the server; then a step of accepting the establishment of a connection by the server at the initiative of the electronic control unit according to a second connection protocol.

Thus, the step of establishing the connection at the initiative of the electronic control unit intervenes subsequently in response to the connection open request according to a second communication protocol.

Thanks to these arrangements, the establishment of the connection according to the second communication protocol is carried out at the initiative of the electronic control unit to the server, subsequently to the connection open request formulated by the server according to the first protocol.

Thus, the establishment of the connection will be enabled by the firewall, because it is at the initiative of the electronic control unit. Afterwards, the server can use the connection according to the second protocol to communicate the useful data corresponding to its connection open request in the downlink message.

These arrangements allow performing the communication of information between the server and the electronic unit downwardly by only using a connection establishment at the initiative of the electronic control unit.

Moreover, the use of two communication protocols allows using a simpler first protocol involving a low use of resources on the server, and a second online protocol involving a more considerable use of resources only when information must be communicated by the server.

In particular, the first protocol is an offline protocol. The second protocol corresponds to an online communication.

According to an aspect of the invention, the first communication protocol is the UDP protocol.

According to an aspect of the invention, the second communication protocol is the TCP protocol.

According to another aspect of the invention, the first and/or the second protocol may be of the Raw IP type or another protocol on top of IP.

The first protocol used may be of various types allowing not to be subjected to the constraints imposed by the firewall.

According to one embodiment, the first communication protocol is a protocol comprising sending of a message from the server to the electronic control unit, in particular an SMS message.

According to another embodiment, the first protocol corresponds to a data supplied in an audio and/or video stream, for example an MPEG stream.

According to an aspect of the invention, the step of transmitting a downlink application message to the electronic control unit is carried out according to the second communication protocol.

According to an aspect of the invention, the method further comprises a first step of periodic reception of an uplink message according to the first communication protocol by the server coming from the electronic control unit; the first step of transmitting according to the first communication protocol a connection open request message comprising a step of transmitting at least one downlink message subsequent to the first reception step.

According to an aspect of the invention, the method further comprises, prior to the first step of transmitting a connection open request, a step of transmitting by the server toward the electronic control unit a downlink message corresponding to an accessibility response.

According to an aspect of the invention, the method comprises a step of receiving an uplink application message by the server coming from the electronic control unit, prior to the step of transmitting a downlink application message, the uplink application message comprising useful data or no useful data at all.

These arrangements allow taking advantage of the established connection to communicate useful data to the electronic control unit.

Moreover, the downlink application message is accepted by the <<firewall>> protecting the private network on which the electronic control unit is linked because said downlink message is interpreted as a response to an uplink message from the electronic control unit.

These arrangements allow carrying out the communication of information between the server and the electronic control unit downwardly by using a mode of requests and responses in the form of uplink and downlink messages at the initiative of the electronic control unit.

As example, a HTTP or HTTPS type communication may be implemented.

It should be noted that not all uplink messages necessarily contain useful data. Thus, in an exchange of request and response in the form of an uplink and downlink message, only the response can contain useful data.

Thus, in response to the uplink message (possibly empty) from the electronic control unit, the server can communicate the useful data corresponding to its connection open request in a response in the form of a downlink message according to the second protocol.

According to an aspect of the invention, the method comprises a step of memorizing useful data comprised in at least one outcoming message and the identifier of the electronic control unit.

According to an aspect of the invention, the memorization step is carried out by memorizing the useful data of one or several outcoming messages corresponding to an identifier of an electronic control unit, the useful data being transmitted afterwards during the transmission step to the electronic control unit corresponding to the identifier.

According to an aspect of the invention, the memorization step is carried out until expiration of a latency time or reception of an uplink application message or establishment of a connection with the electronic control unit. Upon expiration of the latency time, a connection request may be sent by the server to communicate the useful data to the electronic control unit if no connection has been established at the initiative of the latter.

According to an aspect of the invention, the method comprises:
a first step of receiving a first uplink application message by the server coming from the electronic control unit, prior to the step of transmitting a downlink application message, the first uplink application message comprising first uplink useful data; and
a second step of receiving a second uplink application message, subsequently to the first step of receiving a first uplink application message by the server coming from the electronic control unit, prior to the step of transmitting a downlink application message, the second uplink application message comprising second uplink useful data or no useful data at all;

the downlink application message comprising downlink useful data corresponding to a response to the first uplink application message coming from the electronic control unit.

Thanks to these arrangements, the uplink and downlink useful data exchanged during an exchange of request and response, for example according to the http(S) protocol, do not necessarily relate to the same application exchange or application transaction between the electronic control unit and an application module, but to different exchanges or transactions.

The use of this system allows taking advantage of the exchanges to communicate the current data to transfer therethrough, and to simulate a data exchange in the form of request and response, which is a communication mode accepted by the firewall.

According to an aspect of the invention, the first step of receiving the first uplink application message is carried out between a first step of establishing a connection between the server and the electronic control unit and a first step of releasing the connection; the second step of receiving the first uplink application message and the step of transmitting the downlink application message are carried out between a second step of establishing a connection between the server and the electronic control unit, subsequent to the first step of releasing the connection and a second step of releasing the connection.

According to an aspect of the invention, the outcoming message comprises useful data generated by an application module subsequently to an external event.

It should be noted that according to both methods for processing uplink and downlink messages according to the invention described hereinabove, certain steps may be shared. In particular, the steps of connection establishment, the steps of uplink and downlink application messages exchange, and the steps of releasing the connection may be common to both methods.

Thus, in the first method for processing downlink messages, several collection and memorization steps may be carried out pending the establishment of a connection.

This connection may be carried out at the initiative of the electronic control unit, in the context of the transmission of an uplink application message corresponding to a method for processing an uplink application message.

Thus, it should be noticed that the uplink and downlink useful data exchanged during an exchange of request and response, and in particular according to the http(S) protocol, do not necessarily relate to the same application exchange between the electronic control unit and an application module, but to different exchanges.

The use of this system allows taking advantage of the exchanges to communicate the current data to transfer therethrough, and to simulate a data exchange in the form of request and response, which is a communication mode accepted by the firewall.

The present invention also concerns method for processing uplink application messages by an electronic control unit of a home automation installation toward a server comprising the following steps:
a step of memorizing identification data of useful data corresponding to an uplink application message in order to allow correlating said useful data with the useful data of a subsequent downlink application message;
a step of establishing a connection to the server at the initiative of the electronic control unit;
a step of transmitting an uplink application message by the electronic control unit toward the server comprising the useful data and an identifier of the electronic control unit;
a step of accepting the release of the connection immediately or subsequently to a maximum delay.

Thanks to the arrangements according to the invention, it is possible to proceed to the correlation of a request toward the server and the corresponding response without keeping the connection, and thereby release the corresponding resources.

In particular, it is possible to reconstitute the correlation of the responses and requests even if the sequence of the responses does not correspond to the sequence of the application requests.

According to an aspect of the invention, the method comprises a step of receiving a downlink application message by the electronic control unit coming from the server, the downlink application message comprising useful data or no useful data at all.

According to an aspect of the invention, the uplink application message corresponds to a request from the electronic control unit, or still information coming from a sensor, a journal, a response to an order or to a request from the server.

According to an aspect of the invention, memorization is performed if an application response is expected in the case of a request.

The present invention also concerns a method for processing downlink application messages by an electronic control unit of a home automation installation coming from the server comprising the following steps:
a step of establishing a connection between the server and the electronic control unit;
a step of receiving a downlink application message to the electronic control unit, the downlink application message comprising downlink useful data;
a step of accepting the release of the connection immediately or subsequently to a maximum delay;
a step of verifying the correspondence of the downlink useful data with uplink useful data of a previous uplink application message by using memorized identification data of useful data.

According to an aspect of the invention, the method comprises a step of transmitting an uplink application message by the electronic control unit to the server, the uplink application message comprising useful data or no useful data at all.

According to an aspect of the invention, the method comprises a first step of receiving according to a first communication protocol by the electronic control unit a connection open request message coming from the server; the step of establishing a connection to the server being carried out at the initiative of the electronic control unit according to a second connection protocol.

According to an aspect of the invention, the method comprises a first step of periodic transmission of an uplink message according to the first communication protocol by the electronic control unit toward the server, the first step of receiving a connection open request message comprising a step of receiving according to the first protocol at least one downlink message subsequent to the first step of periodic transmission according to the first communication protocol.

The electronic unit being disposed on a private network whose access is conventionally protected by a firewall, the emission of an uplink message allows the server to respond to this message by a downlink message which can reach the electronic unit because it will be considered as a response to the uplink message.

Thus, the periodic sending of an uplink message offers time windows to the server to communicate connection open requests. By choosing a periodicity of the messages smaller than the time window enabled by the firewall to respond to an uplink message, it is possible to permanently maintain a possibility of communication from the server to the electronic control unit, that is to say an open communication channel.

Moreover, a periodic sending allows determining the state of the network link between the electronic control unit and the server.

According to an aspect of the invention, the method comprises, prior to the first step of receiving a connection open request, a step of receiving according to the first communication protocol by the electronic control unit a downlink message coming from the server corresponding to an accessibility response.

The prior step and the second step may be simultaneous, successive and/or have a temporal overlap period. In particular, the prior reception step corresponds to the reception of an accessibility response according to a first delay after the transmission step, in order to maintain the possibility of reception of a second frame according to a second delay.

The second step corresponds to the reception of a connection request during said second delay.

Indeed, it appears that the operation of a conventional firewall may prevent the passage of a downlink message to the extent that the latter is received beyond a first delay after sending of an uplink message. Also in a conventional manner, to the extent that a first downlink message is received, a second longer delay is allotted for receiving one or several other downlink messages.

According to an aspect of the invention, the method comprises a step of monitoring at least one reception delay of a downlink message coming from the server subsequently to the first transmission step, the triggering of a new first transmission step being performed if the at least one reception delay has elapsed.

These arrangements allow holding communication windows open so that the server could communicate.

According to an aspect of the invention, the method comprises a step of transmitting an encryption key by the electronic control unit to the server, so as to enable a signature of the uplink and/or downlink messages according to the first communication protocol and/or according to the second communication protocol.

These arrangements allow performing a signature of the exchanges between the server and the electronic control unit in order to authenticate the two entities in presence, namely the server and the electronic control unit.

According to an aspect of the invention, the method comprises a step of receiving an invalid or expired key indication coming from the server, and in response a new step of transmitting an encryption key.

These arrangements allow reestablishing a communication via the first communication mode in case of expiration of the encryption key.

The present invention also concerns a computer program product comprising program code portions for the execution of the steps of a method for processing uplink messages or downlink messages by a server as previously described.

The present invention also concerns an electronic control unit of a home automation installation comprising a processing unit arranged to contain and execute the computer program product implementing the steps of the method, the electronic control unit further comprising at least one communication interface intended for the command and/or control of at least one actuator, in particular of a movable element of a building, or of another equipment commendable or controllable electrically or electronically, such as for example an alarm system, or of at least one sensor, and a communication interface intended for the communication with a server.

The present invention also concerns a computer program product comprising program code portions for the execution of the steps of a method for processing uplink messages or downlink messages by an electronic control unit as previously described.

The present invention also concerns a server for remote command and/or control of at least one electronic control unit of a home automation installation comprising a processing unit arranged to contain and execute the computer program product implementing the steps of the method, the server further comprising at least one communication interface intended in particular for the communication according to the first communication protocol or the second communication protocol with at least one electronic control unit.

According to an aspect of the invention, the server may also comprise a communication interface intended for the communication with a user interface.

These arrangements enable a remote control of the home automation installation by the user, and sending of orders via the server to the electronic control unit, or obtaining data on the state of the installation.

For example, the user interface may be formed by a web server communicating with a user terminal, for example a computer, a mobile phone or a tablet.

The present invention also concerns a distributed system comprising at least one server and a plurality of electronic control units arranged to communicate with the server so as to implement the method as previously described.

### BRIEF DESCRIPTION OF THE DRAWINGS

The invention will be better understood from the detailed description which is exposed hereinbelow with reference to the appended drawing in which:

FIG. 1 is a diagram illustrating the structure of a system intended for the implementation of a method for processing uplink and downlink application messages between a server and a set of electronic control units of home automation installations.

FIG. 2 is a diagram illustrating the components of the processing unit of the server and their interactions.

FIG. 3 is a diagram illustrating an implementation of a method for processing uplink application messages.

FIG. 4 is a diagram illustrating an implementation of a method for processing downlink application messages.

FIG. 4bis is a diagram illustrating an implementation of a method for processing a plurality of uplink and downlink application messages.

FIG. 5 is a diagram illustrating an implementation of a data transmission method.

FIG. 6 is a diagram illustrating an additional step of the method of FIG. 5.

FIG. 7 is a diagram illustrating the structure of a second system intended for the implementation of a method for data transmission between a server and a set of electronic control units of home automation installations.

### DETAILED DESCRIPTION

In the following detailed description of the figures defined hereinabove, the same elements or the elements filling identical functions may preserve the same references so as to simplify the understanding of the invention.

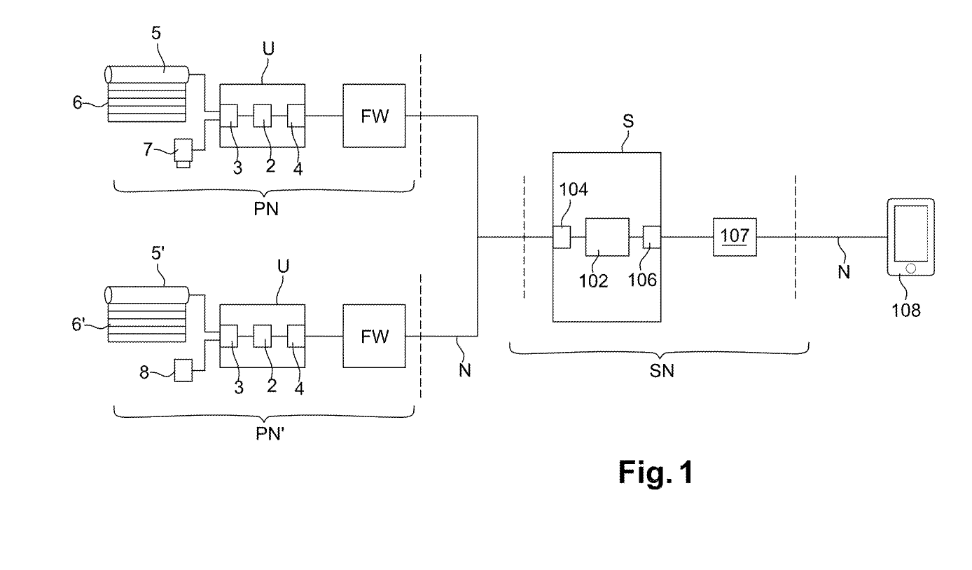

As represented in FIG. 1, a distributed system comprises at least one server S and a plurality of electronic control units U of home automation installations arranged to communicate with the server S so as to implement a data transmission method.

Each electronic control unit of a home automation installation is disposed on a private network PN, PN′, whose access is protected by a firewall FW. The server S is also disposed on a private network NS.

The private networks PN, PN′, SN are linked to a wide area network N, for example the Internet.

In particular, an electronic control unit U of a home automation installation comprises a processing unit 2 arranged to contain and execute a first computer program or a first set of computer programs.

As example, the processing unit 2 comprises a processor, a flash memory for storage as well as a random-access memory, and an Ethernet chip PHY.

The electronic control unit U further comprises at least one communication interface 3 intended for the control/command of actuators of movable elements of a building, of sensors, or still of other electrically or electronically controlled equipment such as an alarm system.

As example, as represented in FIG. 1, the communication interface 3 enables the control and command of at least one actuator 5, 5′ of a movable element of a building, such as for example a rolling shutter 6 or an orientable sunshade 6′ or still the reception of information from a sensor 7 supplying information on the presence of a user or values of the surrounding parameters such as temperature, humidity, luminosity. In the same manner, the interface may enable the control/command of an alarm system 8.

In particular, the communication interface may comprise an lo-homecontrol and/or Zwave and/or WM-Bus radio-frequency chip communicating at a frequency of 868 MHz, and/or an RTS/RTD/RTD+ radio-frequency chip communicating at a frequency of 433 MHz.

Moreover, the electronic control unit U comprises a battery and/or a mains power supply, as well as physical connection ports such as for example USB host, RJ45 and micro-USB.

The electronic control unit U also comprises interface elements such as reset, configuration buttons, tactile buttons for launching scenarios, and/or operation light indicators, such as for example LEDs.

Moreover, the electronic control unit U comprises a communication interface 4 intended for the communication according to the first communication protocol P1 or the second communication protocol P2 with the server S, such as in particular a network interface card which may be the Ethernet PHY chip.

The server S which allows the remote command and/or control of the plurality of electronic control units U of a home automation installation comprises a processing unit 102 arranged to contain and execute a second program or a set of second programs

The server S further comprises at least one communication interface 104 intended for the communication according to the first communication protocol P1 or the second communication protocol P2 with the plurality of electronic control units U.

The server S may also comprise a communication interface 106 intended for the communication with a user interface 107. For example, the user interface 107 may be formed by a web server communicating with a user terminal 108 via the network N, for example a computer, a mobile phone or a tablet.

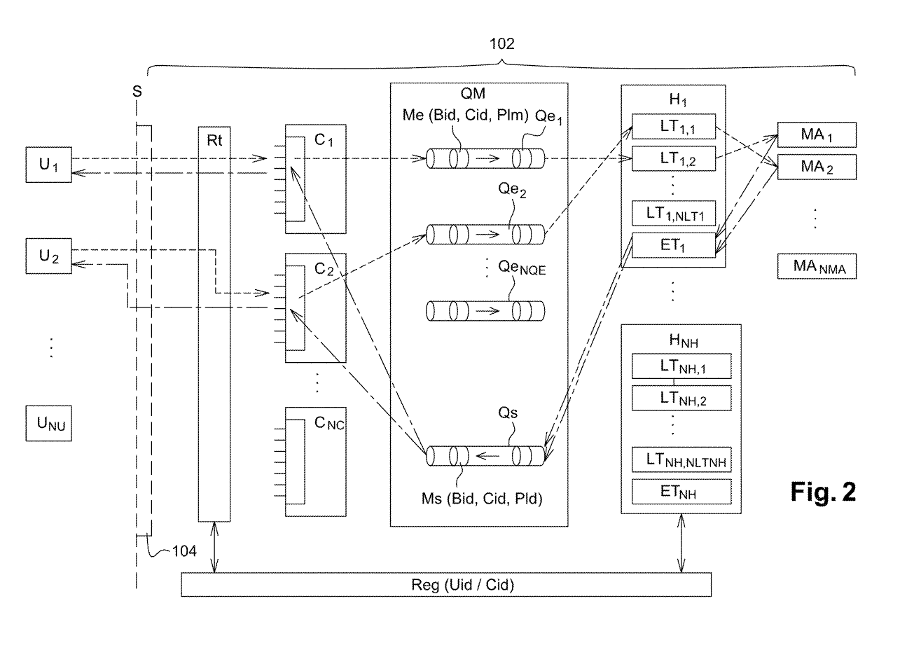

FIG. 2 illustrates the components of the processing unit 102 of the server and their interactions.

It should be noted that the term server is a logical designation which may cover the use of several physical servers to distribute the computer processing load to carry out.

One or several application modules MA are executed on the server. The application modules MA are intended to process the requests coming from the electronic control units U or to generate commands toward the electronic control units U on the basis of external events, such as for example an order communicated by a user via the terminal 108 linked to the web server 107.

The architecture allowing processing of uplink and downlink messages between the communication interface 104 and the application modules MA comprise a plurality of components, and in particular:
a first routing component Rt;
one or several connector instances C;
a queue manager QM allowing the management of a plurality of incoming queues Qe and an outcoming queue Qs;
one or several instances of managers of messages H coming from the queues; and
a repository Reg intended to memorize the associations defined between the connector instances C and the electronic control units U for routing of the communications.

The first routing component is intended to route the messages from the electronic control units U to a connector instance C, in particular according to an identifier of the electronic control unit, such as for example an IP address.

Each connector C allows managing the connection Cnx and the exchange of data with a plurality of electronic control units U in a synchronous manner and communicating in an asynchronous manner by posting or by collecting messages on the incoming Qe, and respectively outcoming Qs, queues of the queue manager QM.

The messages managers H act as an interface between the queues and the application modules MA in input and in output.

The different types of components may be distributed over different physical servers so as to distribute the processing load and allow adaptation to the number of connections to process.

As example, it is possible to provide for a number NC of connector instances, a number NQe of incoming queues on a queue manager QM, a number NH of messages managers each comprising NLT listener instances or listener threads LT on the incoming queues Qe, and a number NMA of application modules or of application module instances.

To the extent that the considered application must ensure that the sequence of the messages coming from an electronic control unit U is upheld, the routing component ensures that the communications coming from an electronic control unit are always routed to the same connector instance C among the NC connector instances. In the same manner, each connector instance C posts the messages relating to an electronic control unit on the same queue Qe among the NQe queues. In this case, a listener or a thread of listeners must listen on one single queue, prior to supplying the application modules.

Thus, in this case, we have a relation: NH*NLT=NQe.

As regards the downlink messages coming from the application modules, in common applications, one single emitter thread ET per message manager H on one single outcoming queue Qs is generally necessary, considering that the downlink traffic is much lower than the uplink traffic. Nonetheless, it would be possible to provide for several downlink queues with a mechanism similar to the uplink queues.

In the case of one single downlink queue, all connector instances C collect messages on said queue Qs by selecting the messages affected thereto, that is to say for example containing their identifier.

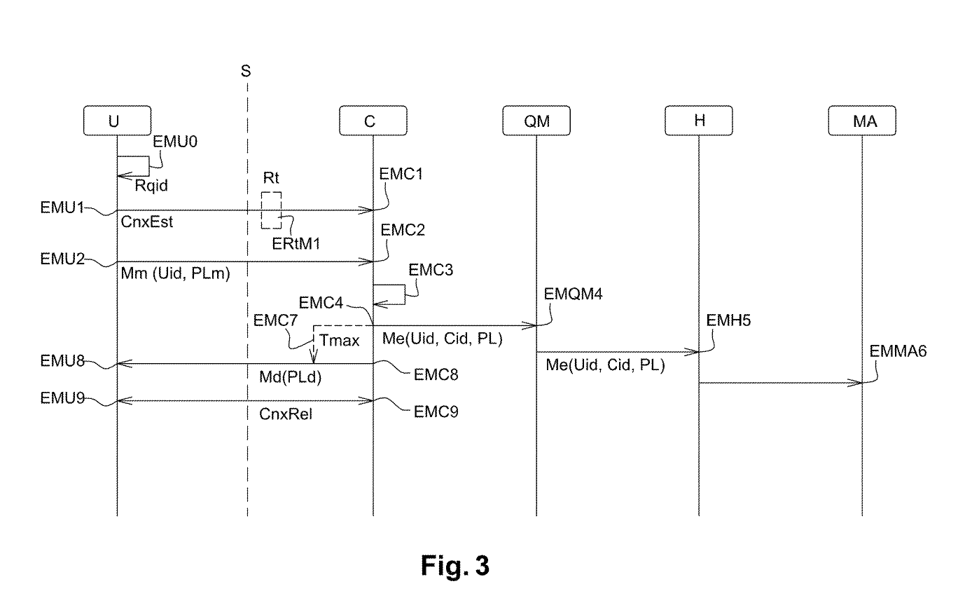

FIG. 3 represents the steps of a method for processing uplink application messages Mm coming from an electronic control unit U of a home automation installation by a server S.

An uplink application message Mm may correspond to a request from the electronic control unit, or still information coming from a sensor, a journal, a response to an order or to a request from the server.

In the case where the uplink message Mm corresponds to a request from the electronic control unit, a step EMUO of memorizing identification data Rqid of useful data Plm is carried out by the electronic control unit U in order to allow correlating said useful data Plm with the useful data Pld of a subsequent downlink message. If the uplink message does not correspond to a request having to prompt a response from the server S, this step may be omitted.

Afterwards, a step EMU1 of establishing a connection Cnx to the server S is carried out at the initiative of the electronic control unit U accepted by the server S at a step EMC1. For example, this connection is carried out according to the TCP communication protocol. A resource reservation is performed by the server S for the management of the connection.

Prior to the step of establishing the connection Cnx, a step ERtM1 of routing the communication to a connector instance C according to the electronic control unit U is carried out, the correspondence between a processing instance C and an electronic control unit U being memorized in the repository Reg. The routing is performed according to an identifier of the electronic control unit, such as for example an IP address.

Once the connection Cnx is established, a step EMU2 of transmitting an uplink application message Mm is carried out by the electronic control unit U, the message being received by a connector instance C at a step EMC2. The uplink message Mm comprises useful data Plm and an identifier Uid of the electronic control unit U.

Afterwards, the connector instance C carries out a step EMC3 of determining an incoming queue Qe, on which an incoming message Me must be posted. This determination step takes into account the identifier of the electronic control unit Uid, for example by implementing the use of a hash function on the basis of the identifier Uid.

Once the queue is determined, a step EMC4 of posting an incoming message Me is carried out. The useful data Plm of the incoming message Me are determined according to the useful data Plm, from the uplink application message Mm. In particular, these may comprise a copy of these useful data Plm. Postage is carried out on the incoming queue Qe for processing by an application module MA. The incoming message Me comprises, in addition to the useful data Plm, an identifier of the electronic control unit Uid and an identifier Cid of the connector instance C.

The incoming message may also comprise a processing priority attribute, the postage step being carried out at a different position of the queue Qe depending on the value of the priority attribute in order to modify its processing order.

A step EMC7 of monitoring a maximum delay Tmax is carried out by the connector before the release of the connection Cnx, this delay allowing for example waiting for a return from an application module to the incoming message, in the form of a downlink message for which a downlink application message could be transmitted by the server toward the electronic control unit.

In particular, the calculation of the delay Tmax may be performed starting from the connection establishment step EMC1, from the postage step EMC3, or still following a step EMC2 of receiving an uplink application message.

In the example represented in FIG. 3, the delay Tmax is counted starting from the postage step EMC4.

Upon expiration of the delay Tmax or beforehand, the connector carries out a step EMC8 of transmitting a downlink message Md to the electronic control unit U which receives it at a step EMUS, in response to the uplink application message Mm.

The downlink message Md may comprise:
useful data Pld corresponding to an application response to the uplink application message Mm if this response is made available by the application module, then posted on the outcoming queue and collected by the connector C before expiration of the delay Tmax;
useful data Pld corresponding to an application exchange other than that involving the uplink message;
or no useful data at all if the connector C has no data to transmit to the electronic control unit U.

In the case represented in FIG. 3, no application response corresponding to the uplink message Mm has been received upon expiration of the delay Tmax. Consequently, the downlink message will comprise either useful data Pld corresponding to an application exchange other than that involving the uplink message; or no useful data at all. Afterwards, a step EMC9 of releasing the connection Cnx is carried out by the connector C and noticed at a step EMU9 by the electronic control unit U.

Subsequently to the postage step EMC4, a listener instance H carries out a collection EMH5 of at least one incoming message Me on an incoming queue Qe. Afterwards, the listener H can communicate the content of the message to an application module MA at a step EMMA6. Afterwards, the application module carries out the processing of the incoming message Me.

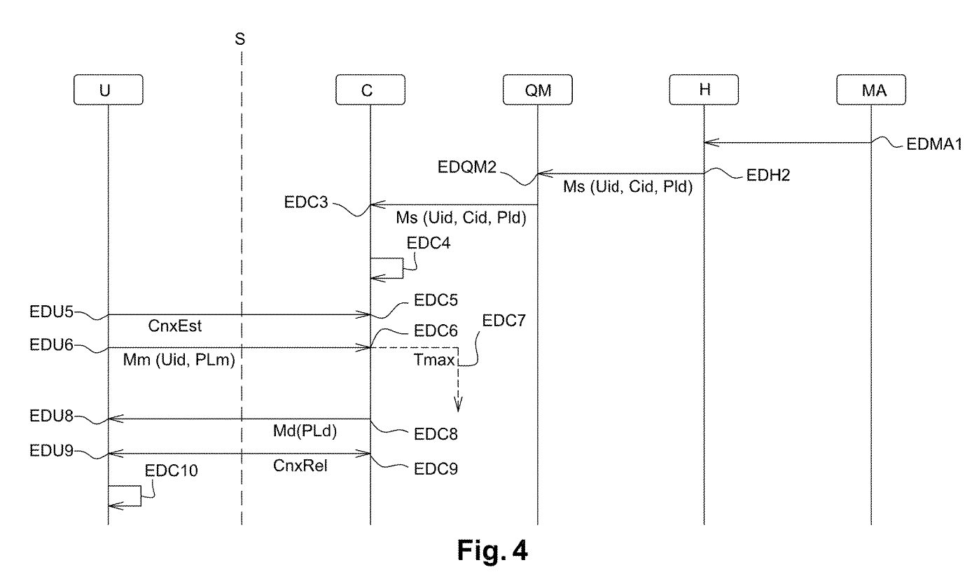

A method for processing downlink message toward an electronic control unit U of a home automation installation by a server S will now be described with reference to FIG. 4.

As previously described, the application modules MA are intended to process the requests coming from the electronic control units U or to generate commands toward the electronic control units U on the basis of external events, such as for example an order communicated by a user via the terminal 108 linked to the web server 107.

Subsequently to these different processings, the application modules MA communicate at a step EDMA1 useful data to an emitter thread ET of a message manager H, by specifying the electronic control unit U addressee of these useful data Pld.

At a subsequent step EDH2, the message manager H posts on the outcoming queue Qs of the queue manager QM an outcoming message Ms comprising an identifier of an electronic control unit Uid, an identifier of a connector Cid and useful data Pld.

The determination of the identifier of the connector Cid is carried out by inquiring the repository Reg in order to determine whether the electronic control unit is associated to a connector or to a connector instance C.

The outcoming message Ms may also comprise a processing priority attribute Pr, the postage step being carried out at a different position of the queue Qs depending on the value of the priority attribute in order to modify its processing order.

Afterwards, the method comprises a step EDC3 of collecting an outcoming message Ms on an outcoming queue Qs coming from an application module MA.

The outcoming messages Ms may comprise useful data Pld corresponding to a response to a previous incoming message Me posted subsequently to a reception of an uplink message Mm coming from the electronic control unit U or still it may comprise useful data Pld generated by an application module MA subsequently to an external event.

Subsequently, a step EDC4 of memorizing useful data Pld comprised in at least one outcoming message Ms and the identifier of the electronic control unit Uid is carried out.

The memorization step EDC4 is carried out by memorizing the useful data Pld of one or several outcoming messages Ms corresponding to an identifier Uid of an electronic control unit U until expiration of a latency time Twait or reception of an uplink application message Mm.

Subsequently, upon completion of the latency time Twait or prior to the reception of an uplink application message Mm, a step EDU5/EDC5 of establishing a connection Cnx between the server S and the electronic control unit U corresponding to the identifier of the electronic control unit Uid comprised in the outcoming message Ms is carried out. This step corresponds either to the establishment of a connection at the initiative of the electronic control unit which has useful data to transmit, or to the establishment of a connection at the initiative of the electronic control unit subsequently to a connection establishment request by the connector as will be detailed later on.

Subsequently to the establishment of the connection Cnx, an uplink message Mm is transmitted at a step EDU6 by the electronic control unit U and received by the server S at a step EDC6, the uplink message Mm comprising useful data Plm or no useful data at all.

Afterwards, a downlink application message Md is transmitted at a step EDC8 to the electronic control unit U which receives it at a step EDU8, the downlink application message Md comprising useful data PLd determined from the useful data Pld of the outcoming message(s) Ms memorized during step EDC4.

Optionally, a step EDC7 of monitoring a maximum delay Tmax may be carried out by the connector before the release of the connection Cnx. In particular, the calculation of the delay Tmax may be performed starting from the connection establishment step EDC5, from a possible step of postage to an incoming queue, or still following a step of receiving an uplink application message EDC6. In the example represented in FIG. 3, the delay Tmax is counted starting from the step EDC6 of receiving an uplink application message. Alternatively, it may be provided for the immediate release of the connection.

Thus, subsequently to the transmission of step EDC8, a step EDC9 of releasing the connection Cnx is carried out, for example at the initiative of the server.

Afterwards, the control unit U may carry out a step EDU10 of verifying the correspondence of the received useful data Pld with a prior request corresponding to a transmission of an uplink message Md by using memorized identification data Rqid of useful data Plm.

It should be noted that according to both implementations of a method for processing uplink and downlink messages according to the invention described hereinabove, certain steps may be shared. In particular, the steps EMU1/EMC1 or EDU5/EDC5 of connection establishment, the steps EMU2/EMC2, EDU6/EDC6 of uplink application messages exchange, the steps EMU8/EMC8, EDU8/EDC8 of downlink application messages exchange, and the steps EMU9, EMC9 of releasing the connection may be common to both methods.

Thus, in the first method described with reference to FIG. 4, several collection EDC3 and memorization EDC4 steps may be carried out pending the establishment of a connection Cnx.

This connection may be performed at the initiative of the electronic control unit U, in the context of the transmission of an uplink application message Mm corresponding to a method for processing an uplink application message.

Thus, it should be noticed that the uplink and downlink useful data circulating during an exchange of request and response, and in particular according to the http(S) protocol, do not necessarily correspond to the same application exchange between the electronic control unit U and an application module MA, but to different exchanges.

The use of this system allows taking advantage of the exchanges to communicate the current data to transfer therethrough, and to simulate a data exchange in the form of request and response, which is a communication mode accepted by the firewall FW.

FIG. 4bis presents a method for processing uplink and downlink application messages in which several connection steps EDU5a/EDC5a, EDU5b/EDC5b and EDU5c/EDC5c and several disconnection steps EDU9a/EDC9a, EDU9b/EDC9b and EDU9c/EDC9c are performed, an uplink message Mm1, Mm2, Mm3 and a downlink application message Md1, Md2, Md3 being exchanged in the context of each of these connections during respective uplink application messages transmission EDU6a, EDU6b, EDU6c and reception EDC6a, EDC6b, EDC6c steps and downlink messages reception EDU8a, EDU8b, EDU8c and transmission EDC8a, EDC8b, EDC8c steps.

Only the steps carried out by the electronic control unit U and the connector are represented in the figure, the steps internal to the server S and to the electronic control unit U being compliant with those described before.

FIG. 4bis illustrates an example, in which two application transactions X, Y involving a request and an application response are carried out.

In particular, the transactions X and Y correspond to requests from the electronic control unit a response to which must be brought by the server.

In the context of the first connection Cnx, the first uplink application message Mm1 comprises useful data PlmX corresponding to the request of the transaction X. The first downlink message Md1 comprises no useful data or still it comprises empty useful data represented by Pldφ.

In the context of the second connection Cnx, the second uplink application message Mm2 comprises useful data PlmY corresponding to the request of the transaction Y. The second downlink message Md2 comprises useful data PldX corresponding to the response of the transaction X.

In the context of the third connection Cnx, the third uplink application message Mm3 comprises no useful data, which is represented by Plmφ). The downlink message Md2 comprises useful data PldX corresponding to the response of the transaction X.

Thus, the uplink and downlink useful data exchanged during an exchange of uplink and downlink messages, for example in a request/response exchange according to the http(S) protocol, do not necessarily relate to the same application exchange or transaction between the electronic control unit and an application module, but to different exchanges or transactions.

The correlation may be carried out at the electronic control unit side thanks to the identification data Rqid of useful data Plm corresponding to an application transaction.

The two methods for processing the uplink and downlink application messages involve the establishment of a connection Cnx between one of the electronic control units U and the server S. Considering that the electronic control unit U is located on a private network PN protected by a firewall, the exchange of data between the server and the plurality of electronic control units must take into account the presence of this firewall. In particular, the establishment of a connection at the initiative of a server external to the private network is conventionally prohibited by a firewall or may be made difficult by the use of a network address translation (NAT) mechanism.

Consequently, in the case where the electronic control unit U does not proceed to a connection for communicating useful data in the uplink direction, it is desirable to provide a mechanism enabling the server to ask the establishment of such a connection.

To this end, the present invention implements a data transmission method enabling in particular the transmission of application messages from the server S to an electronic control unit U.

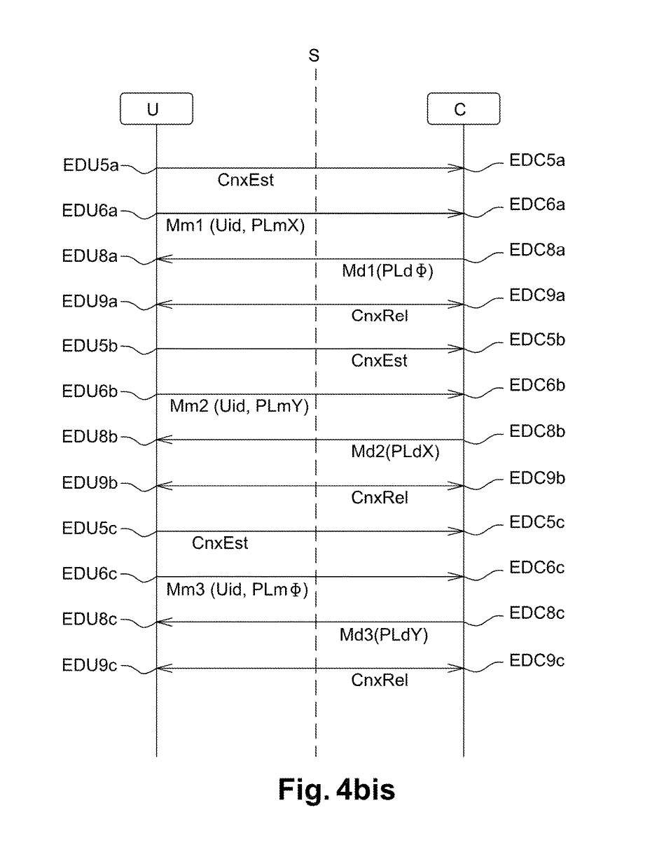

FIG. 5 represents a diagram of an implementation of the data transmission methods executed on the server S, in particular by a connector C and on an electronic control unit U of a home automation installation I.

According to the implementation described in FIG. 5, the method comprises a first phase Ph0 of negotiating a secret key, a second phase Ph1 carried out according to the first communication protocol intended to collect a connection request from the server S and a third phase Ph2 of transmitting data subsequently to the establishment of a connection according to the second communication protocol at the initiative of the electronic control unit.

The secret key negotiation phase Ph0 comprises a step E0 of transmitting an encryption key in a message Mkey by the electronic control unit U to the server S which receives it during a step E0′, so as to enable a signature of the uplink and/or downlink messages according to the first communication protocol P1 and/or according to the second communication protocol P2. In particular, the encryption key may be randomly chosen by the electronic control unit U.

The server acknowledges receipt of the key and validates that it has taken well into account the new key by a downlink message MkeyAck transmitted at a step E1′ which is received by the electronic control unit U during a reception step E1.

The exchanges between the electronic control unit U during the negotiation phase may be carried out according to a communication protocol distinct from or similar to the first communication protocol and the second communication protocol P1 and P2. As example, a HTTPS type protocol may be chosen which allows communicating the key in a secure manner.

It should be noted that this exchange is not carried out frequently, and consequently does not represents significant resources consumption. As example, a periodicity of several days may be provided for the validity of the keys.

The second communication phase Ph1 according to the first protocol P1 comprises a first step E2 of periodic transmission of an uplink message Mping according to the first communication protocol P1 by the electronic control unit U toward the server S which receives it at a step E2′. As example, a periodicity in the range of ten seconds may be provided for the periodicity of the transmission, and in particular in the range of 20 s.

In response to this uplink message, the server S transmits at a step E4′ a downlink message Mpong toward the electronic control unit U which is received at a prior reception step E4 within a first short delay Dr1 after the transmission of the uplink message Mping. As example, the delay D0 may be in the range of a few seconds, and in particular in the range of 5 s.

This first downlink message Mpong allows holding the communication channel open during a second delay Dr2 longer than the first delay Dr1. Indeed, it appears that the operation of a conventional firewall may prevent the passage of a downlink message to the extent that the latter is received beyond a first delay after sending an uplink message. Also in a conventional manner, to the extent that a first downlink message is received, a second longer delay is allotted for receiving one or several other downlink messages. In particular, it is possible to choose triggering a new transmission of the message Mping before the expiration of the delay Dr2.

Subsequently, in the case where the server S has useful data DU to transmit to the electronic control unit U, the latter transmits according to the first communication protocol P1 during a step E5′ a connection open request message Mopen, which is received by the electronic control unit U during a step E5.

The second communication phase Ph1 according to the first protocol P1 comprises a step E3 of monitoring a reception delay Dr of a downlink message coming from the server S subsequently to the first transmission step Mping, the triggering of a new first transmission step E2 being carried out if the reception delay has elapsed.

During this phase, the exchanges are signed with the secret key communicated during the first communication phase Ph0.

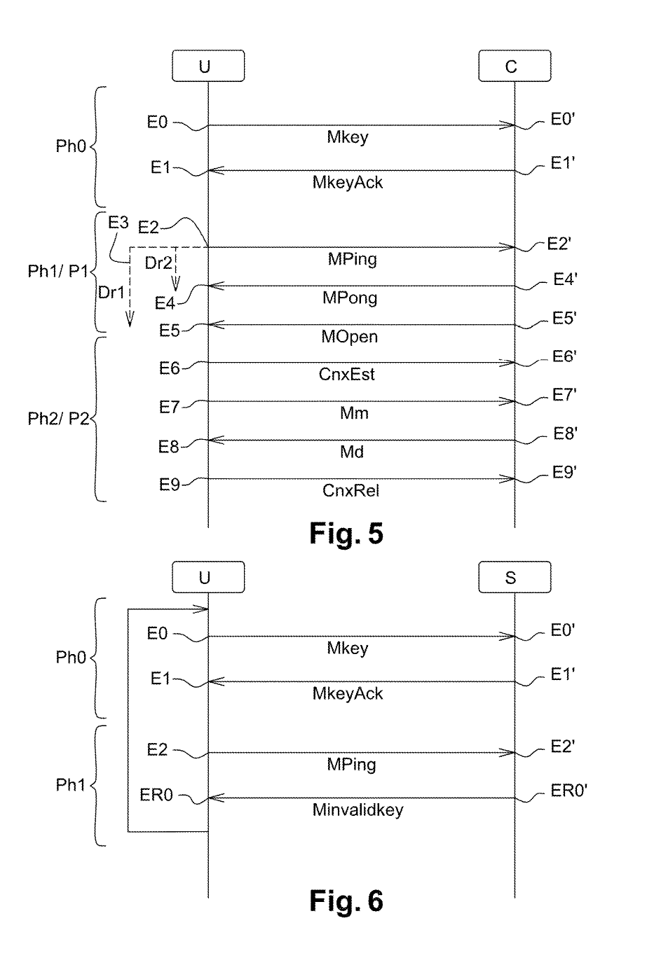

As illustrated in FIG. 6, during the second communication phase Ph1 according to the first communication protocol P1, the server may carry out a step ER0′ of transmitting an invalid or expired key indication Minvalidkey coming from the server S, and in response a new step of transmitting an encryption key E0. Typically, this situation may intervene during the transmission of an uplink message MPing, the server having noticed that the message has a correct format but is not signed with a valid key. It should be noted that in the case of a restart of the electronic control unit, the first communication phase Ph0 with communication of the key is carried out again.

During the second communication phase Ph1, the first communication protocol may in particular be the UDP protocol.

The third phase Ph2 of the method is carried out subsequently to the reception of the connection open request received by the electronic control unit in the second phase at step E5.

At first, a step E6 of establishing a connection Cnx to the server S which accepts this connection at a corresponding step E6′ is carried out, at the initiative of the electronic control unit U according to a second connection protocol P2. In particular, the communication protocol may be the TCP protocol. In this case, the establishment step E6 may comprise several exchanges between the server and the unit U, and in particular exchanges of connection management messages, such as the messages of the TCP SYN, SYN/ACK, ACK protocol.

Once the connection Cnx is established, a step E7 of transmitting an uplink message Mm is carried out according to the second communication protocol P2 toward the server S which receives this message at a step E7′.

In particular, the message Mm may be a message without any useful data but constituting an uplink message a response to which will be brought by the server.

Thus, the server transmits a downlink message Md at a transmission step E8′ toward the electronic control unit U. This downlink message contains the useful data Pld that the server has to transmit to the electronic control unit U.

Subsequently to this exchange, a step E9, E9′ of releasing or accepting the release of the connection Cnx is carried out.

In particular, the second communication protocol used may be the TCP protocol. In particular, the exchanges of steps E7/E7′ and E8/E8′ may be carried out in the form of a request and a response according to the HTTPS protocol which uses TCP.

According to variants of implementation, the release of the connection may intervene after several exchanges of uplink messages and/or receptions of downlink messages according to the second communication protocol or still after a determined delay after the communication establishment step E6.

The steps of establishing E6 the connection and accepting E6′ this connection may respectively correspond to the connection establishment steps EDU5 and EDC5 described with reference to FIG. 4 for the method for transmitting downlink application messages.

The steps of transmitting E7 and receiving E7′ an uplink application message may respectively correspond to the transmission and reception steps EDU6 and EDC6 described with reference to FIG. 4 for the method for transmitting downlink application messages.

The steps of transmitting E8 and receiving E8′ a downlink application message Md may respectively correspond to the transmission and reception steps EDC8 and EDU8 described with reference to FIG. 4 for the method for transmitting downlink application messages.

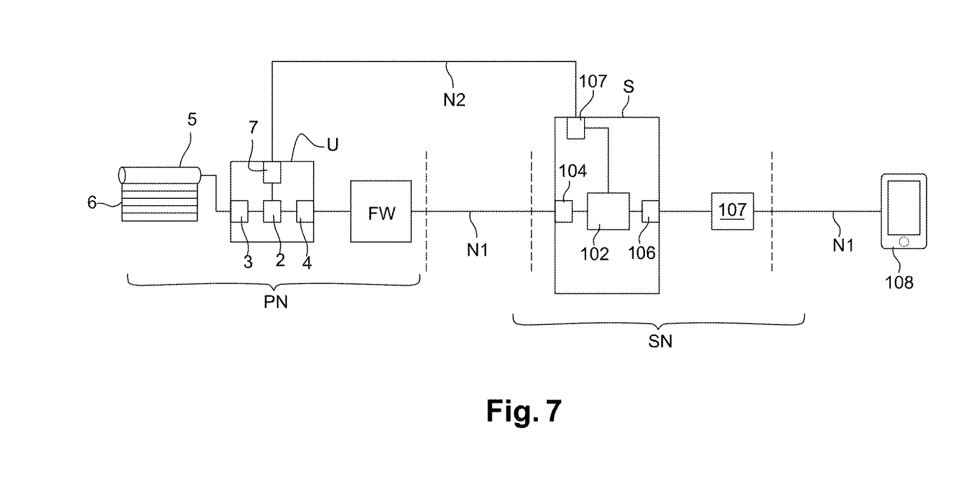

According to a second implementation of a system implementing the invention represented in FIG. 7, the first communication protocol is an SMS-type protocol comprising sensing of a message from the server to the electronic control unit U identified in this case by a telephone number. Thus second protocol is used on a telephone-type network N2, for example a GSM network or wired telephony over Internet, with a function for managing digital messages.

To this end, the server S comprises a communication interface 107 on the network N2, such as for example a GSM card, just as the electronic control unit, which also comprises a communication interface 7 on the network N2, such as a GSM card or a hardware and software module for telephony over Internet, which may be integrated to the firewall or to the electronic control unit U.

Thus, the exchange according to the first protocol and the step of receiving a connection open request simply corresponds to sending SMS between the server S and the electronic control unit U.

FIG. 7 represents only one electronic control unit, but this second embodiment applies of course to communication with a multitude of electronic control units.

According to variants of implementation, the first protocol used may be of various types allowing not to be subjected to the constraints imposed by the firewall.

According to a second variant, the first protocol corresponds to a data supplied in an audio and/or video stream, for example an MPEG stream. According to this variant, the electronic control unit U comprises or is associated to an interface for decoding the corresponding audio and/or video stream.

According to another variant, the first and/or the second protocol may be of the Raw IP type or another protocol on top of IP.

According to variants of the third communication phase Ph2, it is possible that the application exchanges follow the transactions model, comprising a request and a response. The requests are sent in the form of uplink messages, and the responses in the form of downlink messages. Thus, in an exchange of request and response in the form of an uplink, respectively downlink, message, only the response or only the request can contain useful data. An uplink message and the downlink message emitted in return may contain useful data which do not necessarily correspond to the same transaction. For example, a current request requiring an application processing is transmitted in the form of an uplink message, and may trigger the transmission of a downlink message without any useful data, or containing useful data related to a previous request. In the same manner, the application response corresponding to the current request may be sent during a subsequent exchange of uplink message/downlink message. This exchange may comprise an uplink message without any useful data.

According to a variant of the third communication phase Ph2, it is possible that subsequently to the establishment of the connection E6, only one downlink message is transmitted by the server S, without transmission of any uplink message by the electronic control unit. In this case, a protocol other than HTTPS may be used, while leaning on the reliable services provided by a transport protocol operating in the online mode, such as TCP.

It should be noted that the description hereinabove describes methods enabling the transmission of data from the server S to the electronic control unit U.

The data transmission in the direction from the electronic control unit to the server may be carried out for example according to the second communication protocol without difficulty considering that it is possible to directly establish a connection at the initiative of the electronic control unit.

As example, a request and a response according to the HTTPS protocol may be performed, then the established connection is released in order to limit the use of the resources of the server.

It should be noted that the optimization of the network resources enabled by the invention is considerable in the case of a system for connection of a plurality of electronic control units to a server.

In particular, the network resources are necessary for holding a connection at the level of the <<transport>> software layer, on top of the (IP) network layer. This protocol must provide a reliable <<transport>> service to the application, in the called <<online>> mode between the server and each of the electronic control units. The resources allotted to ensure a transport service in the online mode are considerable, because for each connection, buffer memories must be allotted for the incoming data, but also for the outcoming data, because messages having already been transmitted, but not yet acknowledged, must be kept in order to avoid their loss and to enable their possible retransmission. Since the online mode ensures a point-to-point communication, there is one connection per each electronic control unit.

1. A method for processing uplink application messages coming from an electronic control unit of a home automation installation by a server comprising the following steps:
a step of establishing a connection between the server and the electronic control unit;
a step of receiving an uplink application message by the server coming from the electronic control unit;
a step of posting an incoming message, in the case where the uplink application message contains useful data, the incoming message being posted on an incoming queue for processing by an application module, the incoming message comprising useful data determined according to the useful data of the uplink application message and an identifier of the electronic control unit;
a step of releasing the connection immediately or subsequently to a maximum delay (Tmax).

2. The method according to claim 1, comprising a step of transmitting a downlink message to the electronic control unit n response to the uplink application message, the downlink message comprising useful data received beforehand or no useful data at all.

3. The method according to claim 1, comprising a step of determining an incoming queue on which the incoming message must be posted, prior to the postage step, the determination step taking into account the identifier of the electronic control unit (Uid).

4. The method according to claim 1, comprising a prior step of routing the uplink application messages and/or the connection according to the electronic control unit to a processing instance, the correspondence between a processing instance and an electronic control unit being memorized in a repository.

5. The method according to claim 1, comprising a subsequent step of collecting at least one message on an incoming queue by a listener relating to an application module.

6. A method for processing downlink messages toward an electronic control unit of a home automation installation by a server comprising the following steps:
a step of collecting an outcoming message on an outcoming queue coming from an application module, the outcoming message comprising an identifier of an electronic control unit and useful data;
a step of establishing a connection between the server and the electronic control unit corresponding to the identifier of the electronic control unit comprised in the outcoming message;
a step of transmitting a downlink application message to the electronic control unit, the downlink application message comprising useful data determined from the useful data of the outcoming message;
a step of releasing the connection immediately or subsequently to a maximum delay.

7. The method according to claim 6, comprising a step of receiving an uplink application message by the server coming from the electronic control unit, prior to the step of transmitting a downlink application message, the uplink application message comprising useful data or no useful data at all.

8. The method according to claim 6, comprising a step of memorizing useful data comprised in at least one outcoming message and the identifier of the electronic control unit.

9. The method according to claim 8, wherein the memorization step is carried out by memorizing the useful data of one or several outcoming messages corresponding to an identifier of an electronic control unit, the useful data being transmitted afterwards during the transmission step to the electronic control unit corresponding to the identifier.

10. The method according to claim 6, comprising:
a first step of receiving a first uplink application message by the server coming from the electronic control unit, prior to the step of transmitting a downlink application message, the first uplink application message comprising first uplink useful data; and
a second step of receiving a second uplink application message, subsequently to the first step of receiving a first uplink application message by the server coming from the electronic control unit, prior to the step of transmitting a downlink application message, the second uplink application message comprising second uplink useful data or no useful data at all;
the downlink application message comprising downlink useful data corresponding to a response to the first uplink application message coming from the electronic control unit.

11. The method according to claim 6, wherein the outcoming message comprises useful data generated by an application module subsequently to an external event.

12. A method for processing uplink application messages by an electronic control unit of a home automation installation toward a server comprising the following steps:
a step of memorizing identification data of useful data corresponding to an uplink application message in order to allow correlating said useful data with the useful data of a subsequent downlink application message;
a step of establishing a connection to the server at the initiative of the electronic control unit;
a step of transmitting an uplink application message ( by the electronic control unit toward the server comprising the useful data and an identifier of the electronic control unit;
a step of accepting the release of the connection immediately or subsequently to a maximum delay.

13. The method according to claim 12, comprising a step of receiving a downlink application message by the electronic control unit coming from the server, the downlink application message comprising useful data or no useful data at all.

14. A method for processing downlink application messages by an electronic control unit of a home automation installation coming from the server comprising the following steps:
a step of establishing a connection between the server and the electronic control unit;
a step of receiving a downlink application message to the electronic control unit, the downlink application message comprising downlink useful data;
a step of accepting the release of the connection immediately or subsequently to a maximum delay;
a step of verifying the correspondence of the downlink useful data with uplink useful data of a previous uplink application message by using memorized identification data of useful data.

15. The method according to claim 14, comprising a step of transmitting an uplink application message by the electronic control unit to the server, the uplink application message comprising useful data or no useful data at all.
